(19) United States
(12) Patent Application Publication
(10) Pub. No.: US 2026/0211083 A1
(43) Pub. Date: Jul. 23, 2026

(54) A METHOD FOR SELECTING TARGETS FOR LIDAR IN AUTOMATED MODE

(71) Applicant: SEC TECHNOLOGIES, S.R.O., Liptovsky Mikulas (SK)

(72) Inventor: Michal Simko, Bratislava (SK)

(21) Appl. No.: 19/140,576

(22) PCT Filed: Dec. 29, 2022
(86) PCT No.: PCT/SK2022/000008

§ 371 Date: Jun. 18, 2025

(30) Foreign Application Priority Data
Dec. 19, 2022 (SK) PP 129-2022
Dec. 19, 2022 (SK) PUV 174-2022

(51) Int. Cl. G01S 7/48; G01S 17/08; G01S 17/86; G01S 17/89

(52) U.S. Cl. CPC G01S 7/4808; G01S 17/08; G01S 17/86; G01S 17/89

(57) ABSTRACT

A method for selecting targets for LIDAR, in which a digital image is created in a wide field of view, in which LIDAR measurement is performed. The device is rectified with a LIDAR detector. On the digital image, objects suitable for the reflection of the laser beam of the LIDAR are detected. The detected objects are joined into groups of objects that are located in physical proximity to each other. Subsequently, the LIDAR measures the distance to the designated groups of objects, whereas if the distance to a group of objects is measured, this group of objects is selected into the group of suitable targets for detection and measurement by LIDAR, and if the distance to a group of objects is not measured, the group of objects is excluded from the group of suitable targets for detection and measurement by LIDAR.

### FIELD OF TECHNOLOGY

The invention relates to a method for selecting targets suitable for measurement using a laser system operating with the LIDAR (Light Detection And Ranging) technology.

### BRIEF DESCRIPTION OF THE DRAWINGS

FIG. 1 illustrates a LIDAR system for the method according to this invention.

### DETAILED DESCRIPTION

A laser system operating with the LIDAR technology needs a suitable reflecting surface to function effectively, a target from which the emitted laser beam will be reflected and subsequently returned to the receiver. A suitable target must meet several parameters, in particular, it must be visible, it must be at a distance that is greater than the minimum detection distance of the system and at the same time it is smaller than the maximum detection distance of the system, and it must have suitable reflection parameters for the laser beam.

LIDAR systems function in two modes. In one mode, they are controlled by the operator, who controls the system manually, and thus suitable targets for measurement must be selected manually by the operator based on his experience. The second mode is automated, when the LIDAR system scans the space without operator intervention or with minimal intervention. However, in automated mode, the system scans the space in defined increments, i.e. the system moves by a defined value in the axes of freedom, i.e. the system moves by a defined value in the axes of freedom, e.g. the measurement is performed every angular degree in the horizontal plane.

Both above stated modes have the disadvantage of work inefficiency and consequently of long duration of measurement using the LIDAR system. In manual mode, the source of inefficiency is the operator. Although the selection of targets and the number of measurements can be almost optimal for the operator, this requires the expertise of the operator, which is not transferable and requires considerable training. In the second mode, the main source of inefficiency is the number of measurements, part of which may not find a suitable target for measurement and therefore the data obtained in this way are unusable.

The aim of this invention is to substantially eliminate the disadvantages described herein.

The above stated aim is achieved by the method for selecting targets for LIDAR in an automated mode according to the present invention. The essence of the invention consists in the fact that a digital image of the environment is created using a device for creating an image recording of the environment in a wide field of view, in which LIDAR measurement is performed, while this device is rectified with a LIDAR detector. On the digital image of the environment, objects suitable for the reflection of the laser beam of the LIDAR are subsequently detected. These objects are subsequently joined into groups of objects that are located in physical proximity to each other. The detection of objects suitable for the reflection of the LIDAR laser beam and their joining into groups of objects is performed by software processing of the digital image, which can be performed by a separate computer or also in the LIDAR detector.

Subsequently, the LIDAR measures the distance to the designated groups of objects, whereas if the distance to a group of objects is measured, this group of objects is selected into the group of suitable targets for detection and measurement by LIDAR. If the distance to a group of objects is not measured, the group of objects is excluded from the group of suitable targets for detection and measurement by LIDAR.

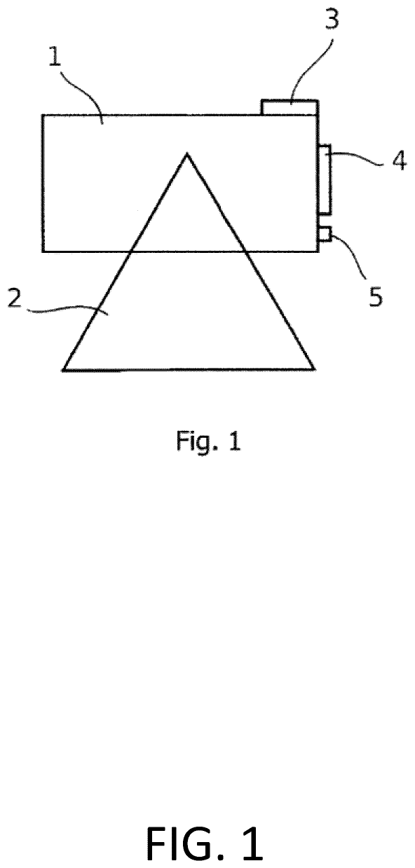

The invention is explained in more detail in FIG. 1, which schematically displays the LIDAR system for the method according to this invention.

### Examples of the Embodiment of the Invention

The selection of targets for LIDAR in the automated mode according to this invention is performed in such a way that a digital image of the environment in which the LIDAR measurement will be performed is created using a device 3, which is capable of making an image recording of the environment in a wide field of view. In this case, the device 3 is placed on the LIDAR detector 1, or within the entire LIDAR system, which typically includes the LIDAR detector 1 with the transmitter 5 and the receiver 4 of the laser beam located on an adjustable device 2. The device 3 is also rectified with LIDAR detector 1 so that they face the same direction.

The device 3, which is capable of making an image recording of the environment in a wide field of view, can be for example a camera.

On the digital image of the environment created by the device 3, objects that may be suitable for reflecting the laser beam emitted by the LIDAR transmitter 5 are subsequently detected. These objects are subsequently joined into groups of objects that are located in physical proximity to each other and thus have a similar distance from the LIDAR detector 1, or of the entire LIDAR system including also the device 3.

The detection of objects suitable for the reflection of the LIDAR laser beam and their joining into groups of objects is performed by software processing of the digital image, which can be performed by a separate computer or also in the LIDAR detector 1.

Subsequently, the LIDAR measures the distance to the designated groups of objects, whereas if the distance to a group of objects is measured, this group of objects is selected into the group of suitable targets for detection and measurement by LIDAR. If the distance to a group of objects is not measured, it means that the group of objects is not within the range of LIDAR detector 1 and is excluded from the group of suitable targets for detection and measurement by LIDAR.

The selection of targets that reach suitable parameters is automated, while the number of necessary measurements performed by the LIDAR itself is significantly reduced, as the number of measurements that do not find a suitable target for measurement is significantly reduced, thereby also reducing the amount of unusable data from these measurements. Also, since it is an automated mode, when the LIDAR system scans the space without operator intervention or with minimal operator intervention, the operator or the user of such a LIDAR system does not need to have expert knowledge acquired over a long period of time. The methods described herein may be performed utilizing one or more processors, memory, and/or network interfaces.

As used herein, a processor may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

The memory may include volatile and nonvolatile memory, removable and non-removable media implemented in any method or technology for storage of information, such as non-transitory computer-readable instructions, data structures, program component, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory discussed herein may include at least one operating system (OS) component that is configured to manage hardware resource devices such as the network interface(s), the I/O devices of the respective apparatuses, and so forth, and provide various services to applications or components executing on the processors.

The network interface(s) may enable messages between the components and/or devices shown in environment and/or with one or more other remote systems, as well as other networked devices. Such network interface(s) may include one or more network interface controllers (NICs) or other types of transceiver devices to send and receive messages over the network.

For instance, each of the network interface(s) may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) may include a wide area network (WAN) component to enable message over a wide area network.

1. (canceled)

2. (canceled)

3. (canceled)

4. A method for selecting targets for LIDAR in an automated mode, comprising:
creating a digital image of an environment using a device for creating an image recording of the environment in a wide field of view;
performing a LIDAR measurement, while the device is rectified with a LIDAR detector, on the digital image of the environment;
detecting, based on processing of the digital image, objects suitable for reflection of a laser beam of the LIDAR;
subsequently joining, based on processing of the digital image, the objects into groups of objects that are located in physical proximity to each other;
measuring, using the LIDAR, a distance to designated groups of the objects; and
selecting a specific group of the objects based on the measuring as a group of suitable targets for detection and measurement by the LIDAR, wherein other groups of the objects are excluded from the group of suitable targets for detection and measurement by the LIDAR.

5. The method according to claim 4, wherein the processing of the digital image is performed by a separate computer or in the LIDAR detector.

6. The method according to claim 4, wherein the device for creating the image recording of the environment in the wide field of view is a camera.
